(19) United States
(12) Patent Application Publication
(10) Pub. No.: US 2023/0139750 A1
(43) Pub. Date: May 4, 2023

(54) SHAVING CARTRIDGES

(71) Applicant: BIC Violex Single Member S.A., Anoixi (GR)

(72) Inventors: Vasileios NTAVOS, Anoixi (GR); Georgios KOULOURIAS, Anoixi (GR); Panagiotis KOPELAS, Anoixi (GR); Dimitrios EFTHIMIADIS, Anoixi (GR); Ioannis MALLIAROS, Anoixi (GR)

(73) Assignee: BIC Violex Single Member S.A., Anoixi (GR)

(21) Appl. No.: 17/802,276

(22) PCT Filed: Dec. 17, 2020
(86) PCT No.: PCT/EP2020/086686

§ 371 Date: Aug. 25, 2022

(30) Foreign Application Priority Data
Feb. 26, 2020 (EP) 20159535.2

(51) Int. Cl. B26B 21/22; B26B 21/40

(52) U.S. Cl. CPC B26B 21/227; B26B 21/4012

(57) ABSTRACT

A cartridge for a shaving device having one or more blades for use on a surface comprising a base including a base first end and a base second end offset from an axis of the cartridge, said base being configured to carry a blade, a frame configured to cooperate with the base, said frame included at the base first end and the base second end, said frame defining an opening configured to expose the blade, wherein the cartridge further includes one or more resilient elements configured to cooperate with a corresponding blade, and wherein, the base, the resilient elements and the frame are each constructed of sheet metal.

### CROSS REFERENCE TO RELATED APPLICATION(S)

This application is a National Stage Application of International Application No. PCT/EP2020/086686, filed on Dec. 17, 2020, now published as WO2021170280A1 and which claims benefit from European patent application EP20159535.2 filed on 26 Feb. 2020, the entire contents being incorporated herein by reference.

### FIELD

The present disclosure relates generally to the field of skincare, and in particular to shaving. More specifically, the present disclosure relates to a cartridge of a handheld shaving device constructed of a rigid material and configured to allow movement razor blades.

### BACKGROUND

A typical handheld shaving device may include a handle and a shaving cartridge (head). The shaving cartridge may include one or more razor blades (hereafter, “blades”) configured to pass along the skin of a user to shave and/or groom hair of the user. Many conventional shaving cartridges may be constructed of plastic due to ease, simplicity, and cost of manufacturing. However, the usage of suitable plastics to manufacture shaving cartridges may be harmful for the environment. Additionally, manufacturing a shaving cartridge which may accommodate and/or allow movement of blades may present difficulties, as dimensions for necessary structures of the shaving cartridge may typically be small, have complex geometrical shapes, and require precision to manufacture.

It is desirable to provide an improved cartridge for a handheld shaving device that fulfills one or more of the needs described above.

### SUMMARY

According to aspects of the present disclosure, a cartridge for a shaving device having one or more blades for use on a surface comprises a base including a base first end and a base second end offset from an axis of the cartridge, the base being configured to carry a blade. A frame configured to cooperate with the base, the frame included at the base first end and the base second end, the frame defining an opening configured to expose the blade. The cartridge further includes one or more resilient elements configured to cooperate with a corresponding blade. The base, the resilient elements and the frame are each constructed of sheet metal.

According to aspects of the present disclosure, the resilient elements are arranged between the base first end and the base second end.

According to aspects of the present disclosure, the base and the resilient element may be formed from one piece of sheet metal.

According to aspects of the present disclosure, the base and the frame may be formed from one or two pieces of sheet metal.

According to aspects of the present disclosure, the resilient element may be capable of axial flexure.

According to aspects of the present disclosure, movement of the blade along the surface in a first direction relative to the axis may cause the resilient element to flex in a second direction relative to the axis.

According to aspects of the present disclosure, the resilient element may comprise a plurality of support fingers extending from a support root.

According to aspects of the present disclosure, the support root may extend from and along one or both of the base first end and base second end.

According to aspects of the present disclosure, the support root may extend axially between the base first end and the base second end, and the support fingers may extend towards one or both of the base first end and the base second end.

According to aspects of the present disclosure, a blade-receiving void may be defined within each support finger.

According to aspects of the present disclosure, the base may include a first plane and a second plane offset from the first plane in a direction transverse to the axis, and the resilient element may extend from the first plane to the second plane.

According to aspects of the present disclosure, the resilient element may include a proximal section and a distal section, and the distal section may be planar with respect to the first and second planes.

According to aspects of the present disclosure, the distal section of the resilient element may be configured to support a terminal portion of the blade and the proximal section may be configured to support a core portion of the blade.

According to aspects of the present disclosure, the frame may include one or more engagement elements configured to secure the base at the base first end and the base second end.

According to aspects of the present disclosure, a method of allowing movement of blades within a housing of a shaving device may comprise the cartridge according to any aspect described above.

In the manner described and according to aspects illustrated herein, the metal resilient element provided on the cartridge may allow for movement of blades while also reducing cost and complexity of manufacturing.

### BRIEF DESCRIPTION OF THE DRAWINGS

Aspects of embodiments of a cartridge will be described with reference to the drawings, where like numerals reflect like elements:

FIG. 1 is a front perspective view of a cartridge according to aspects of the disclosure;

FIG. 2 is a front perspective view of a blade for use within the cartridge of FIG. 1 according to aspects of the disclosure;

FIG. 3 is a front perspective view of a base of the cartridge of FIG. 1 according to aspects of the disclosure;

FIG. 4 is a front perspective cross-sectional view of the base of FIG. 3, taken along line IV of FIG. 3;

FIG. 5 is a front perspective view of a frame of the cartridge of FIG. 1 according to aspects of the disclosure;

FIG. 6 is front view of the cartridge of FIG. 1;

FIG. 7 is a front perspective view of the cartridge of FIG. 1, shown without blades;

FIG. 8 is a front perspective view of the cartridge of FIG. 7;

FIG. 9 is a front perspective view of the cartridge of FIG. 7 with emphasis on a pair of fasteners according to aspects of the disclosure;

FIG. 10 is a front perspective view of an alternative embodiment of a cartridge in an unformed state according to aspects of the disclosure;

FIG. 11 is a front perspective view of the cartridge of FIG. 10 in a formed state;

FIG. 12 is a bottom cross-sectional view of the cartridge of FIG. 11, taken along line XII of FIG. 11;

FIG. 13 is a partial bottom perspective cross-sectional view of the cartridge of FIG. 11, taken along line XIII of FIG. 11;

FIG. 14 is a front perspective view of the cartridge of FIG. 11, shown with blades;

FIG. 15 is a side perspective cross-sectional view of the cartridge of FIG. 11, taken along line XV of FIG. 11; and

FIG. 16 is a side perspective cross-sectional view of the cartridge of FIG. 11, taken along line XVI of FIG. 11.

### DETAILED DESCRIPTION

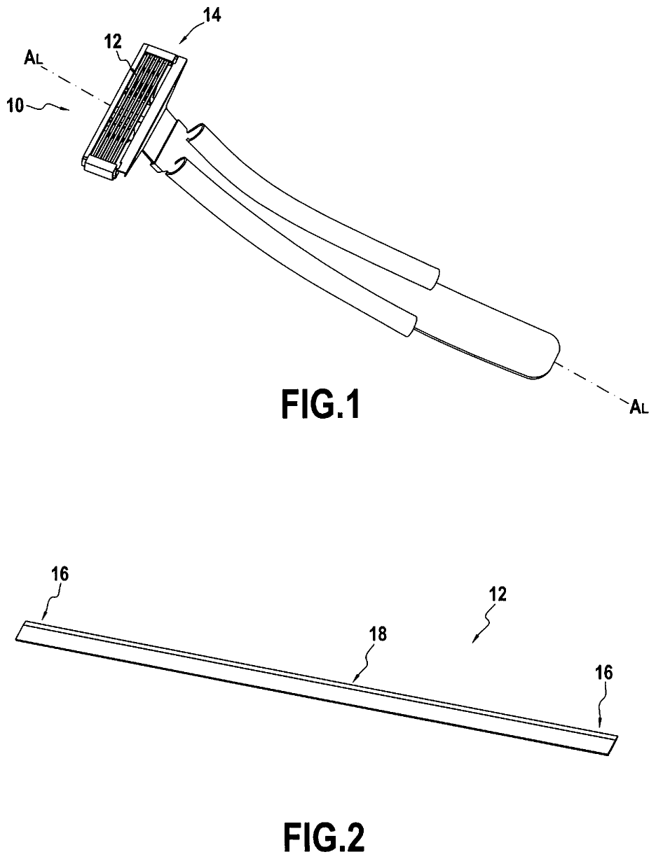

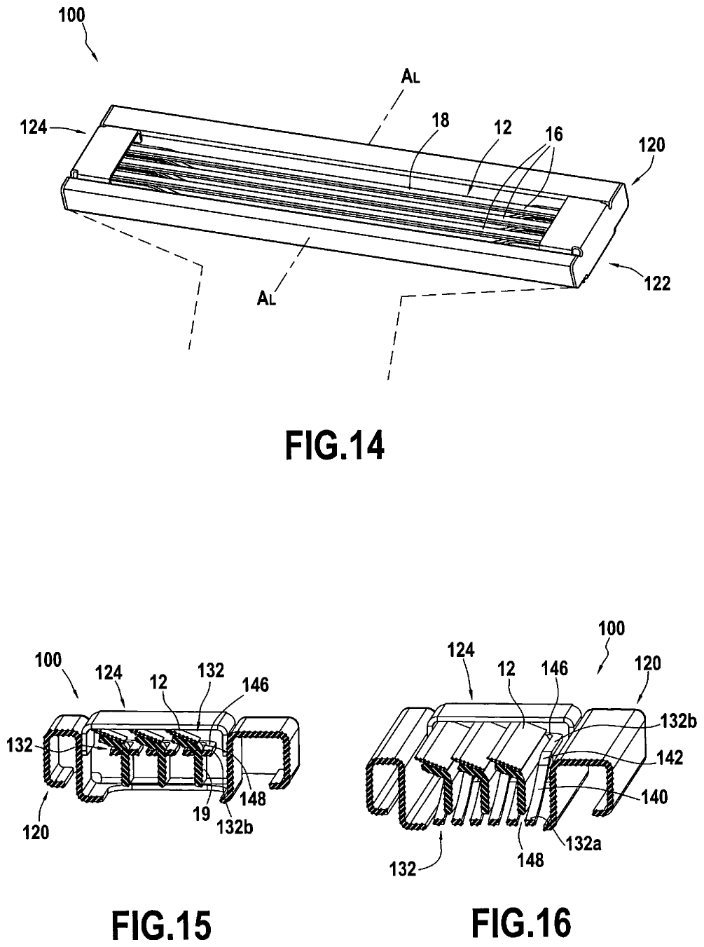

Embodiments of a cartridge according to aspects of the disclosure will now be described with reference to FIGS. 1-16, wherein like numerals represent like parts, and will generally be referred to by the reference numerals 10 and 100. Although the cartridge 10, 100 is described with reference to specific examples, it should be understood that modifications and changes may be made to these examples without going beyond the general scope as defined by the claims. In particular, individual characteristics of the various embodiments shown and/or mentioned herein may be combined in additional embodiments. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

Various materials, methods of construction and methods of fastening will be discussed in the context of the disclosed embodiment(s). Those skilled in the art will recognize known substitutes for the materials, construction methods, and fastening methods, all of which are contemplated as compatible with the disclosed embodiment(s) and are intended to be encompassed by the appended claims.

As used in this disclosure and the appended claims, the singular forms “a,” “an,” and “the” include plural referents unless the content clearly dictates otherwise. As used in this disclosure and the appended claims, the term “or” is generally employed in its sense including “and/or” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like fashion (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present disclosure.

As shown in FIGS. 1-6, the cartridge 10 may be configured to allow movement of a blade 12 within a housing 14 constructed of a rigid material. In embodiments, the blade 12 may have a pair of terminal portions 16 and a core portion 18 extending between the terminal portions 16 (see FIG. 2). The cartridge 10 may be configured for use as a head/cartridge 10 on a handheld shaving device 100 for shaving and/or grooming hair of a user. To this end, the cartridge 10 may be configured for movement along a surface, such as the skin of the user, in a plurality of directions. However, for the purposes of illustrating usage of the cartridge 10 herein, the directions of use of the cartridge 10 along the surface will be referred to as a first direction and a second direction different from the first direction. Therefore, it should be understood that any reference to the first direction and the second direction does not limit any aspect of the cartridge 10 to only two directions. Referring to FIGS. 1, 3, and 5-6, the cartridge 10 may include a housing 14 configured to receive one or more blades 12. In embodiments, the housing 14 is configured to receive a plurality of blades 12. The housing 14 may include a base 20 and a frame 60 centered on an axis AL extending through the cartridge 10. In embodiments, the base 20 and the frame 60 may be constructed from two pieces of sheet metal. The usage of sheet metal, and/or the minimal amount of sheet metal/components used, may allow for increased cost efficiency, increased simplicity of the manufacturing process, and increased sustainability. Additionally, the modularity of the base 20 and the frame 60 described herein may allow for increased interchangeability of the base 20 with alternative configurations of the frame 60. Further, the modularity may allow for enhanced ease of manufacture and increased quality control.

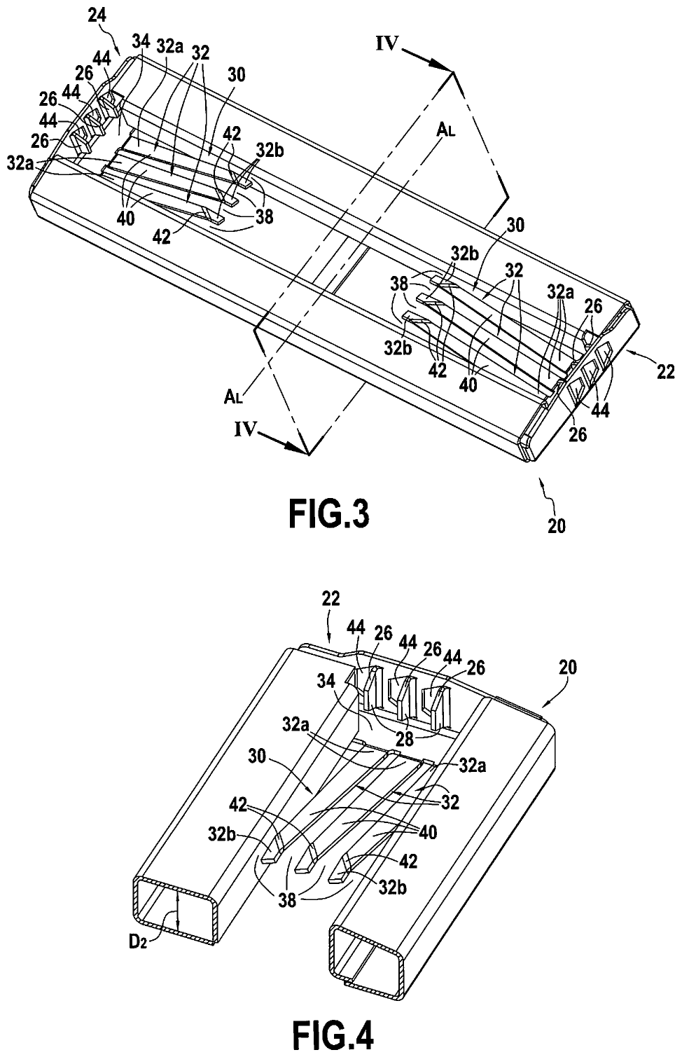

As shown in FIGS. 3-4, the base of the cartridge 10 may include a base first end 22 and a base second end 24 extending about the axis A_{L}. In embodiments, the base 20 may be constructed of stainless steel, which is heat-treated after sheet metal forming, however, a person having ordinary skill in the art would appreciate that other metals may be suitable for the cartridge 10. The base first end 22 and the base second end 24 may extend parallel to the axis A_{L}. The base first end 22 and/or the base second end 24 may each include one or more attachment elements 26 configured to hold and position a blade 12 and/or an extension thereof. In embodiments, the base first end 22 and the base second end 24 may include a plurality of opposing pairs of attachment elements 26. Each attachment element 26 may include an attachment surface 28 (see FIG. 4) configured to engage the terminal portions 16 of the blade 12, such that the blade 12 extends from one attachment element 26 to a corresponding attachment element 26 in a given pair of opposing attachment elements 26. A support or resilient element 30 is provided to cooperate with a corresponding blade 12. The resilient element 30 is arranged between the base first end 22 and the base second end 24 to cooperate with the corresponding blade 12 between the base first end 22 and the base second end 24. It should be understood that the term “cooperate” as used herein may be defined as “function with,” “work jointly with,” and/or “provide support for.” In embodiments, cooperation between the support 30 and the blade 12 may mean that the support 30 may be configured to allow movement of the blade 12 and ensure correct placement of the blade 12 within the cartridge 10. Each of the attachment element 26 and the support 30 may be configured to be large in size and without complex geometry in order to simplify manufacturing of the cartridge 10. The support 30 may be elastically deformable to allow for axial movement of the blade 12. In embodiments, the support 30 may have a spring force of between 10±5 (gr) and 10±5 (gr). In embodiments, the support 30 may have a spring force of 30±5 (gr). In embodiments, the support 30 may have a thickness of between 0.05 (mm) and 3.50 (mm). In embodiments, the support 30 may have a thickness of 0.20 (mm).

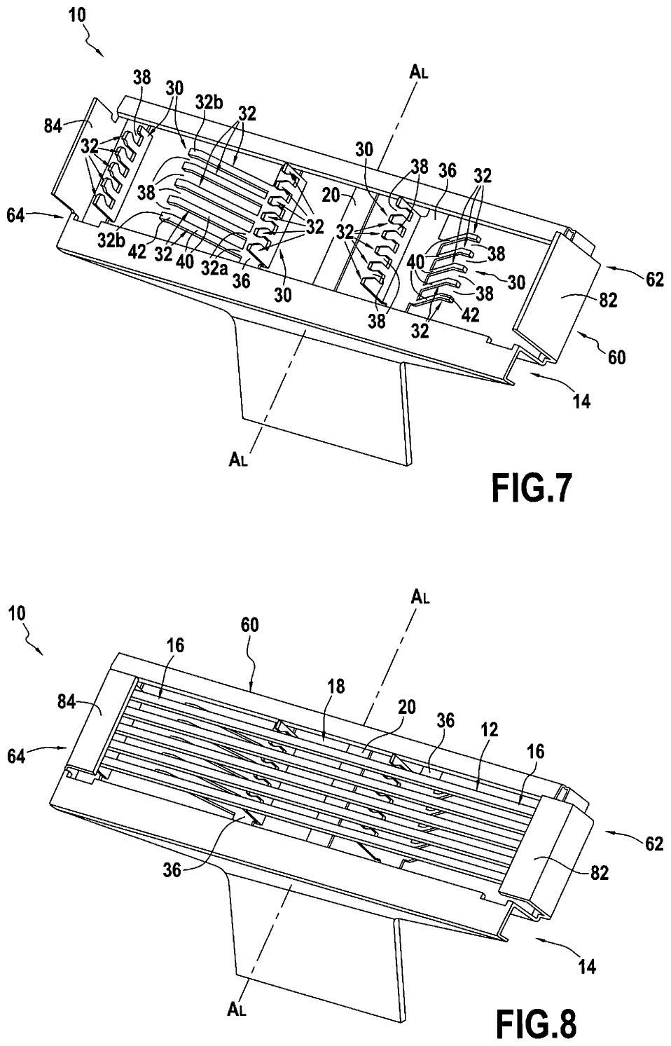

Referring to FIGS. 3-4, in embodiments, the support 30 may comprise a plurality of opposing pairs of supports (support fingers) 32 that are arranged between the base first end 22 and the base second end 24. Each support finger 32 may extend from a support root 34, which may extend from and along the base first end 22 and the base second end 24. Each support finger 32 may extend inwardly from a proximal section 32a of the support finger 32 connected to the support root 34 on the base first end 22 and the base second end 24. Each support finger 32 may extend toward the axis A_{L} to a distal section 32b of the support finger 32. Additionally or alternatively, one or more central support roots 36 (see FIGS. 7-8) may extend axially between the base first end 22 and the base second end 24 along the axis A_{L} and/or offset from the axis A_{L}. Each support finger 32 extending from the central support root 36 may extend inwardly toward the axis A_{L}, or away from the axis A_{L} and toward one of the base first end 22 or the base second end 24. The support fingers 32 may be arranged in series such that a slot 38 is defined between each adjacent support finger 32. Each slot 38 may have a width of between 0.10 (mm) and 1 (mm). In embodiments, the width of the slot may be 0.50 (mm). Each slot 38 may extend from the base first end 22 to the base second end 24. Each slot 38 may be configured to receive a corresponding blade 12 and allow room for flexure of each support finger 32. Each corresponding blade 12 may extend throughout the slot 38 so that the terminal portions 16 of the blade 12 are engaged by corresponding attachment surfaces 28 of the attachment elements 26. Each blade 12 is supported axially by the support fingers 32 defining the corresponding slot 38, which each blade 12 extends through.

In embodiments, the support fingers 32 may be capable of axial flexure to allow for axial movement of the blades 12 during use of the cartridge 10 along a surface. As a user pushes the cartridge 10 on or along the surface and applies a force in a first direction, the surface may exert a reaction force on the blades 12 in a second direction. The reaction force on the blades 12 in the second direction may cause the blades 12 to transmit the reaction force to the support fingers 32, which causes the support fingers 32 to flex in the second direction in response to the reaction force exerted on the blades 12. Therefore, movement of the cartridge 10 in a first direction or a second direction along the surface causes the blades 12, and thus the support fingers 32, to move and/or flex in the first direction or the second direction.

In embodiments, the blade 12 may include a blade support 19 and be mounted at a position on top or below the corresponding support finger 32 (see FIG. 15). At either position, the support finger 32 may contact the blade support 19 and elastically bias the blade 12 and blade support 19 towards a rest position within the slot 38. Alternatively, the blade support 19 may be an integrally formed component having a bent portion (see FIG. 15). In this case, the support finger 32 may contact the bent portion during use and bias the blade 12 and the bent portion towards the rest position.

Referring to FIGS. 3-4, the base 20 may be oriented in a first plane P₁ and a second plane P₂. The second plane P₂ may be offset from the first plane P₁ in a direction transverse to the axis A_{L}. The support root 34 and/or central support root 36 may be located within the first plane P₁ of the base 20. The proximal section 32a of each support finger 32 may extend from the support root 34 and/or central support root 36 within the first plane P₁ to the distal section 32b at a position within the second plane P₂. The distal section 32b of each support finger 32 may be substantially planar with respect to the second plane P₂. To extend from the first plane P₁ to the second plane P₂, each support finger 32 may include a slope 40 leading to the distal section 32b and a bend 42 positioned between the slope 40 and the distal section 32b. With respect to the distal section 32b, the slope 40 and the bend 42 may be considered to be part of the proximal section 32a. As the blade flexes, the bend 42 may establish a point of contact between the blade 12 and the support finger 32 so that the support finger 32 may support the core portion 18 of the blade 12 at the point of contact as the blade 12 flexes. As such, the positioning of each support finger 32 within both of the first plane P₁ and the second plane P₂ may allow each support finger 32 to have more than one point of contact with the corresponding blade 12 when supporting the blade 12 during use. In particular, a given blade 12 may be supported by one or more of a corresponding attachment element 26 at each of the first base end 22 and the second base end 24, a corresponding bend 42 of a support finger 32 extending from the support root 34 at the base first end 22 and the base second end 24, and/or a corresponding bend 42 of a support finger 32 extending from a central support root 36.

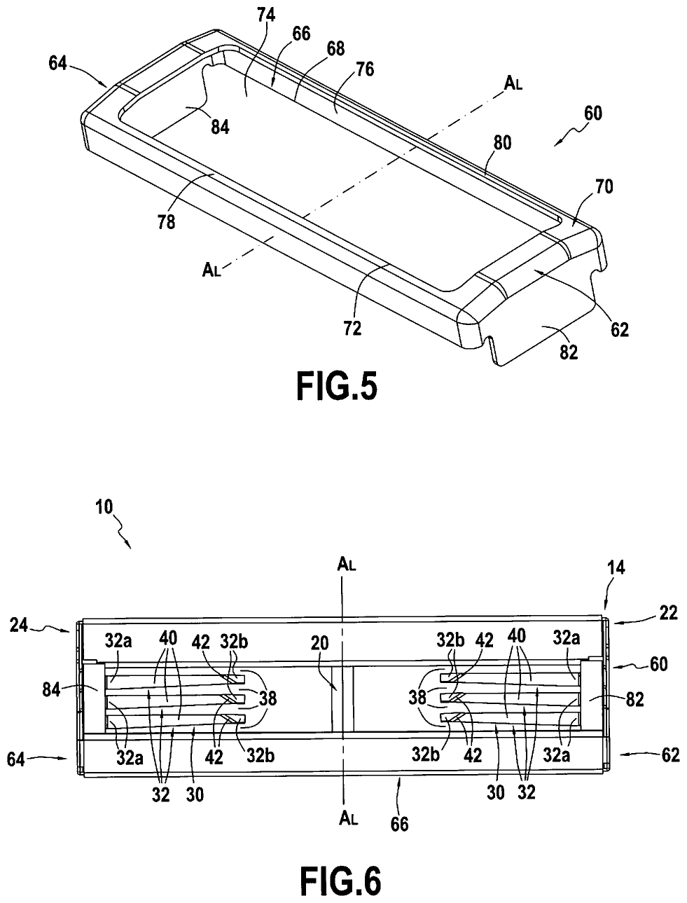

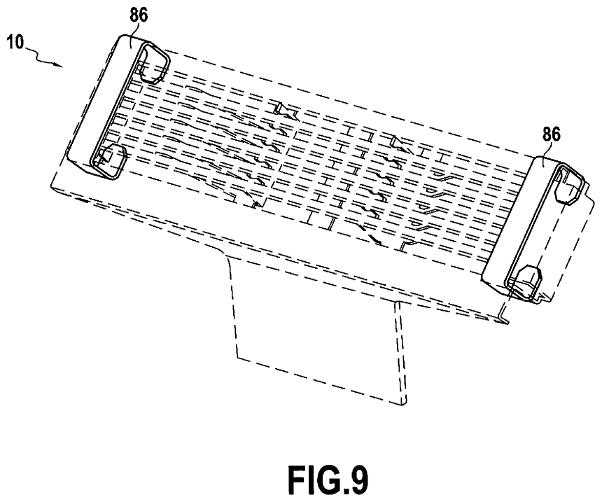

As shown in FIG. 5-6, the frame 60 may be configured to cooperate with the base 20. The frame 60 may include a frame first end 62 and a frame second end 64 complementary to the base first end 22 and the base second end 24, respectively. In embodiments, the frame 60 is constructed of aluminum to enhance anti-corrosion, however, a person having ordinary skill in the art would appreciate that other metals may be suitable for the cartridge 10. The frame 60 may include a first side 66 defining a first opening 68 extending between the frame first end 62 and the frame second end 64 for receiving the base 20. The first opening 68 may allow exposure of the blades 12 carried by the base 20. The frame 60 may include a second side 70 opposing the first side 66 and defining a second opening 72 extending between the frame first end 62 and the frame second end 64. The second opening 72 may also allow for exposure of the blades 12 carried by the base 20 as well as drainage of fluid out of the base 20 during use. It is contemplated that the base first end 62 and the base second end 64 may each include drainage holes 44 (see FIGS. 3-4) to further facilitate drainage of fluid from the base 20. The first opening 66 may lead to a cavity 74 defined by a sidewall 76 extending between the first side 66 and the second side 70 of the frame 60. The base 20 may be received in the cavity 74 and securely surrounded by the sidewall 76. The cavity 74 and sidewall 76 may have a depth D₁ which corresponds to a depth D₂ (see FIG. 4) of the base 20. The depth D₁ corresponding to the depth D₂ may ensure a secure fit of the frame 60 over the base 20. The frame 60 may include a first protective bar 78 and a second protective bar 80 extending between the frame first end 62 and the frame second end 64. The first protective bar 78 and second protective bar 80 may provide a safety boundary between the base 20 and a surface on which the cartridge 10 is used. The frame 60 may include a first engagement element (retainer) 82 extending from the frame first end 62 and a second engagement element (retainer) 84 extending from the frame second end 64 for securing the base 20 and the blades 12 within the frame 60. In embodiments, each engagement element 82, 84 may be a flap extending away from the second side 70 of the frame 60 and past the first side 66 of the frame 60. Each engagement element 82, 84 may be configured to bend and fold over the first side 66 of the frame 60 and the base first end 22 and base second end 24 to hold the base 20 within the frame 60. The engagement element 82, 84 may also be configured to secure the blade 12 within the base 20. As shown in FIG. 9, additionally or alternatively, a fastener (clip) 86 may extend around each of the frame first end 62 and frame second end 64 and the base first end 22 and the base second end 24. The fastener 86 may hold the base 20 within the frame 60 and/or hold each of the engagement elements 82, 84 in a folded configuration over the first side 66 of the frame 60 and the base first end 22 and base second end 24.

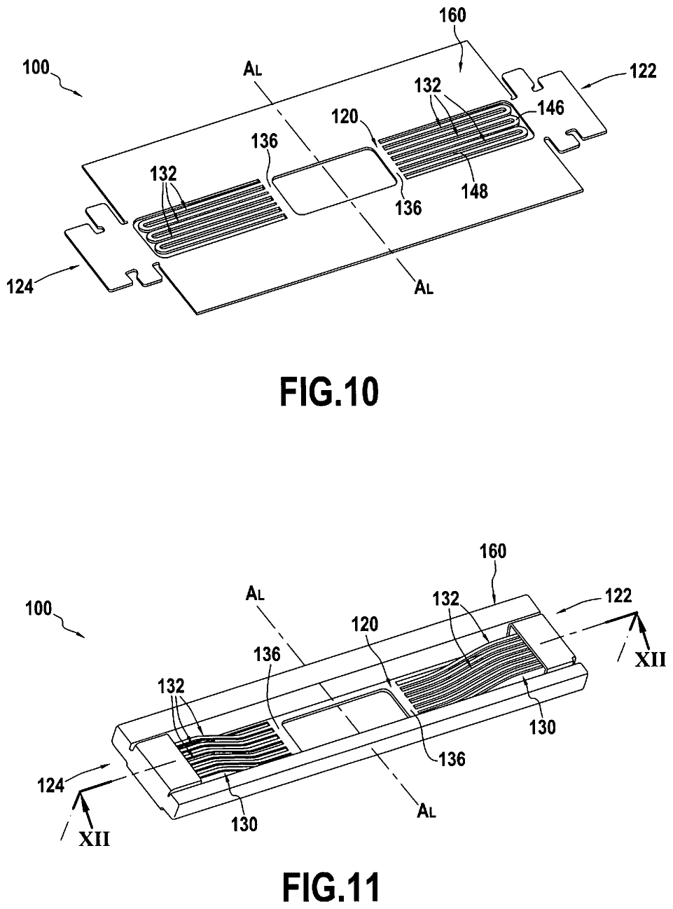

As shown in FIGS. 10-16, an alternative embodiment of the cartridge 10 is shown and referred to by reference numeral 100. With respect to the cartridge 100, structures and/or relationships that may be the same or similar to the structures and/or relationships of the cartridge 10 may utilize the same or similar name and corresponding reference numeral as the structures and/or relationships of the cartridge 10. The cartridge 100 is discussed herein with reference to the aspects that may differ from the cartridge 10. It is contemplated that the same or similar structures and/or relationships of the alternative embodiment may function the same or similarly to the same or similar structures and/or relationships of the cartridge 10. Additionally, it is contemplated that aspects of the cartridge 100 may be combinable with aspects of the cartridge 10 described above. Referring to FIGS. 10-11, a base 120, resilient elements 130 and a frame 160 of the cartridge 100 may be formed of one piece of sheet metal. Therefore, the cartridge 100 is capable of transitioning from a flat, unformed state (see FIG. 10) to an integral, multi-dimensional, formed state (see FIG. 11). The frame 160 may be connected to the base 120 rather than defining an opening 68 for receiving the base 120.

As such, the frame 160 may surround the base as an extension of the base 120. The frame 160 may fold inwardly and be mechanically formed around the base 120.

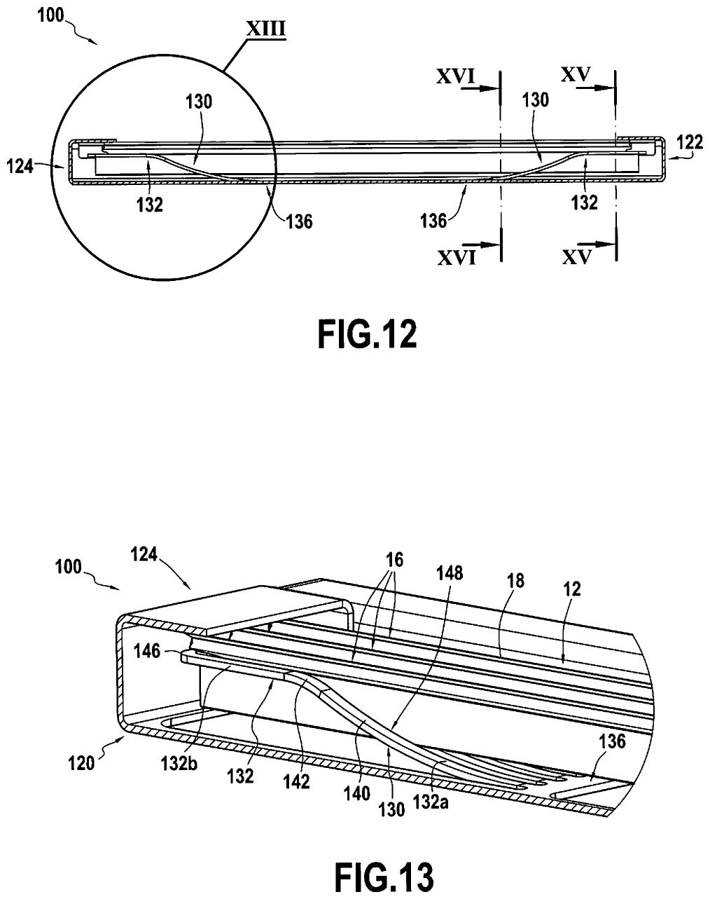

Referring to FIGS. 10-11, the base 120 may include a first central support root 136 and a second central support root 136. The first central support root 136 may include a plurality of support fingers 132 extending towards a base first end 122 and the second central support root 136 may include a plurality of support fingers 132 extending towards a base second end 124 to define the resilient element 130 configured to cooperate with a corresponding blade, which is arranged between the base first end 122 and the base second end 124. Additionally or alternatively, the support fingers 132 may extend inwardly from a support root 34, which may extend from and along the base first end 122 and the base second end 124. Additionally or alternatively, the base first end 122 and 124 may be formed and/or function similarly to the first and second engagement elements 82, 84. Referring to FIG. 13, each support finger 132 may extend from a proximal section 132a connected to the first central support root 136 or the second central support root 136. Each support finger 132 may extend away from an axis A_{L} toward one of the base first ends 122 or the base second end 124 to a planar distal section 132b. In embodiments, each support finger 132 extending from the first central support root 136 extends towards the base first end 122 and each support finger 132 extending from the second central support root 136 extends towards the base second end 124. Referring to FIGS. 12-13, each support finger 132 may include a slope 140 throughout the proximal section 132a and a bend 142 positioned between the slope 140 and the distal section 132b.

Each support finger 132 may include a rounded end 146 at the distal section 132b. The rounded end 146 may reduce the complexity of the geometry of the support fingers 132 to simplify the manufacturing process. Each support finger 132 may define a void (blade-receiving void) 148 extending from the corresponding first or second central support root 136 and/or the proximal section 132a to the rounded end 146 and/or the distal section 132b. The void 148 may be configured to receive a corresponding blade 12. In embodiments, the planar distal section 132b of each support finger may have a length between 1 (mm) and 10 (mm). In embodiments, the planar distal section 132b of each support finger may have a length between 3 (mm) and 6 (mm). In use, the distal section 132b and/or rounded end 146 of each support finger may support the terminal portion 16 of the corresponding blades 12 and the proximal section 132a and/or the bend 142 of each support finger 132 may support the core portion 18 of the blades 12. Axial flexure of the support fingers 132 may allow for support and/or movement of the blades 12 in the manner described with respect to the cartridge 10.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

1. A cartridge for a shaving device having one or more blades for use on a surface, the cartridge comprising:
a base including a base first end and a base second end offset from an axis of the cartridge, the base being configured to carry a blade;
a frame configured to cooperate with the base, the frame included at the base first end and the base second end, the frame defining an opening configured to expose the blade;
wherein the cartridge further includes one or more resilient elements configured to cooperate with a corresponding blade, and wherein, the base, the resilient elements and the frame are each constructed of sheet metal.

2. The cartridge of claim 1, wherein the resilient elements are arranged between the base first end and the base second end.

3. The cartridge of claim 1, wherein the base and the resilient element are formed from one single piece of sheet metal.

4. The cartridge of claim 1, wherein the base and the frame are formed from one or two pieces of sheet metal.

5. The cartridge of claim 1, wherein the resilient elements are configured for axial flexure.

6. The cartridge of claim 5, wherein movement of the blade along the surface in a first direction relative to the axis causes the resilient element to flex in a second direction relative to the axis.

7. The cartridge of claim 1, wherein the resilient elements comprise a plurality of support fingers extending from a support root.

8. The cartridge of claim 7, wherein the support root extends from and along one or both of the base first end and base second end.

9. The cartridge of claim 7, wherein the support root extends axially between the base first end and the base second end, and the support fingers extend towards one or both of the base first end and the base second end.

10. The cartridge of claim 7, wherein a blade receiving void is defined within each support finger.

11. The cartridge of claim 1, wherein the base includes a first plane and a second plane offset from the first plane in a direction transverse to the axis, and the resilient element extends from the first plane to the second plane.

12. The cartridge of claim 11, wherein the resilient element includes a proximal section and a distal section, the distal section being planar with respect to the first and second planes.

13. The cartridge of claim 12, wherein the distal section of the support fingers is configured to support a terminal portion of the blade and the proximal section is configured to support a core portion of the blade.

14. The cartridge of claim 1, wherein the frame includes one or more engagement elements configured to secure the base at the base first end and the base second.

15. A method of allowing movement of blades within a housing of a shaving device comprising the cartridge of claim 1.
